(19) United States
(12) Patent Application Publication
(10) Pub. No.: US 2016/0198267 A1
(43) Pub. Date: Jul. 7, 2016

(54) Increased Compliance Flat Reed Transducer

(71) Applicant: Knowles Electronics, LLC, Itasca, IL (US)

(72) Inventor: Mekell Jiles, Flossmoor, IL (US)

(21) Appl. No.: 15/071,658

(22) Filed: Mar. 16, 2016

Related U.S. Application Data
(63) Continuation of application No. 14/490,225, filed on Sep. 18, 2014, now Pat. No. 9,326,074.
(60) Provisional application No. 61/881,646, filed on Sep. 24, 2013.

(51) Int. Cl. H04R 11/02

(52) U.S. Cl. CPC H04R 11/02

(57) ABSTRACT

A hearing device receiver includes a coil having a passage and an armature having a deflecting portion, a support portion, and a base portion interconnecting the deflecting portion and the support portion. The deflecting portion of the armature is disposed through the passage of the coil and between magnets of the receiver. A housing is disposed about the coil, the magnets and at least a portion of the armature. The support portion of the armature is fastened to the housing, and the base portion of the armature is unfastened to the housing. The deflecting portion of the armature is flexible relative to the base and the support portions thereof and free to move between the magnets in response to an excitation signal applied to the coil.

### CROSS REFERENCE TO RELATED APPLICATIONS

This application is a continuation of prior U.S. application Ser. No. 14/490,225 entitled “Increased Compliance Flat Reed Transducer,” filed Sep. 18, 2014, which claims benefit under 35 U. S.C. §119 (e) to U.S. Provisional Application No. 61/881,646 entitled “Increased Compliance Flat Reed Transducer,” filed Sep. 24, 2013, the content of all of which are incorporated herein by reference in their entireties.

### TECHNICAL FIELD

This disclosure relates to acoustic devices and, more specifically, to reeds or armatures used in these devices.

### BACKGROUND

Various types of microphones and receivers have been used through the years. In these devices, different electrical components are housed together within a housing or assembly. For example, a receiver typically includes a coil, bobbin, stack, among other components and these components are housed within the receiver housing. Other types of acoustic devices may include other types of components.

Generally speaking, a receiver motor typically includes a coil, a yoke, an armature, and magnets. An electrical signal applied to the coil creates a magnetic field within the motor which causes the armature to move. The armature, sometimes referred to as a reed, forms a part of the magnetic circuit. The armature is coupled to a diaphragm. The moving diaphragm produces sound and this sound is presented to a user.

As mentioned, a receiver typical includes a reed or armature. The reed, in some instances, may be U-shaped (in the cross section). In other cases, the reed may be E-shaped and generally flat (in the cross section). In some aspects and circumstances, the E-shaped flat design yields a better performance than U-shaped armatures. Unfortunately, the E-shaped flat design also tends to be stiffer because it is often much shorter than the curved U-shaped armature. The stiffness may in effect negate at least some of the benefits of the E-shaped flat design. This has led to some user dissatisfaction with these previous approaches and has sometimes limited the usage of E-shaped armatures in receivers.

### BRIEF DESCRIPTION OF THE DRAWINGS

For a more complete understanding of the disclosure, reference should be made to the following detailed description and accompanying drawings wherein:

FIG. 1 is a perspective view of a receiver with an E-shaped armature;

FIG. 2 is a cross-sectional view taken along line A-A of the receiver of FIG. 1;

FIG. 3 is a cross-sectional view taken along line B-B of the receiver of FIG. 1; and

FIG. 4 is an exploded perspective view of the receiver of FIG. 1.

Those of ordinary skill in the art will appreciate that elements in the figures are illustrated for simplicity and clarity. It will be appreciated further that certain actions and/or steps may be described or depicted in a particular order of occurrence while those of ordinary skill in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

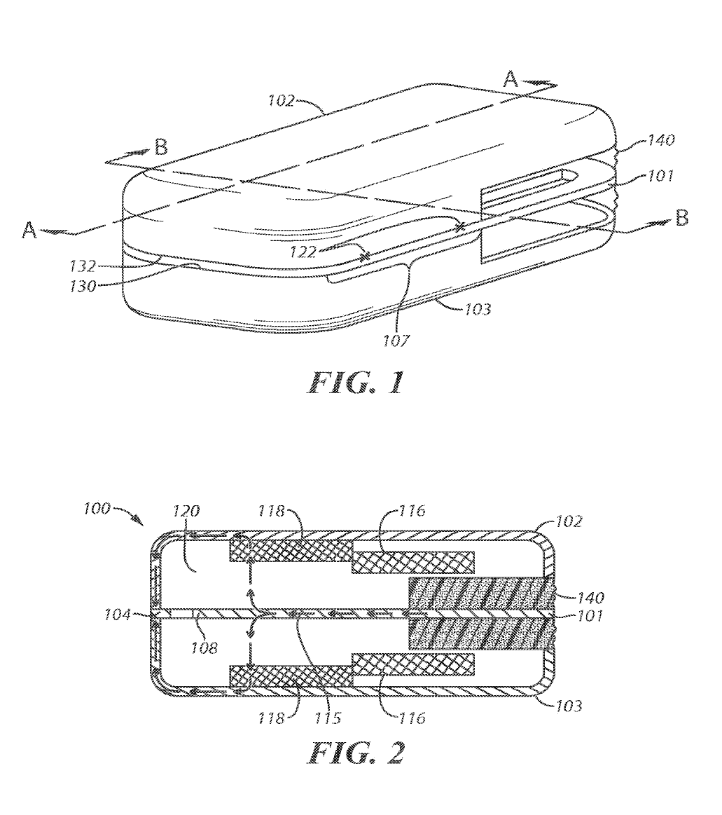

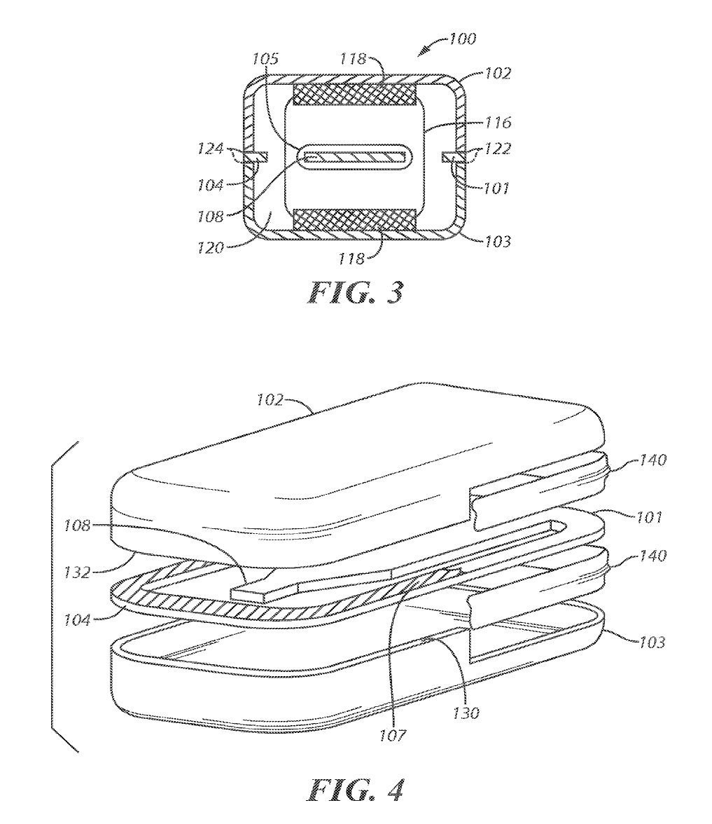

Referring now to FIG. 1, FIG. 2, FIG. 3, and FIG. 4 one example of a receiver 100 having a flat reed 101 or armature is described. It will be appreciated that although the armatures and reeds described herein are generally E-shaped, other non-E-shaped designs can also be employed.

The flat reed 101 is enclosed in a top assembly (or housing) 102 and a bottom assembly (or housing) 103. The reed 101 has an outer member 104 and a central member 108. The central member 108 of the reed 101 is disposed in a tunnel 105 between a coil 116 and magnets 118. A portion of the outer member 104 is in contact with and welded (or otherwise attached) to the top assembly 102 and the bottom assembly 103 as is a front portion 107 of the reed 101. As mentioned, welds can be used to secure the elements together. However, other attachment mechanisms such as using glues or other adhesives may also be used.

The magnets 118 may include a stack assembly that is created with a suitable material for a magnetic flux flow to be maintained. Both the magnets 118 may be attached (via any suitable attachment mechanism) to the top assembly 102 and to the bottom assembly 103.

In operation, a flux is introduced through the coil 116, the central member 108 of the reed 101 moves, and this moves a rod (not shown in the figures) that is attached to a diaphragm thereby moving the diaphragm (also not shown in the figures) producing sound energy that can be presented to a user at a port (also not shown in the figures). A magnetic flux path 115 is created as shown in FIG. 2. The flux path 115 (forming a magnetic circuit) extends through the magnets 118 (including a stack assembly) through the assemblies 102 and 103, and then is completed by flowing through the central member 108 of the reed 101.

Looking at an end view shown in FIG. 3, if A is the cross section area of the central member 108, B is the cross-sectional area of the outer member 104 then in one case A=B and in another case A<B. However, it cannot be the case that A>B. This is because a certain amount of flux flows through A and this cannot be more than the total amounts that can flow through B. If this were the case, then performance problems could develop in the receiver 100 because more flux would be entering the area B than could be handled in effect creating a flux bottleneck.

It can be seen that the end of the central member 108 of the reed 101 can freely move. The top assembly 102 and the bottom assembly 103 include a stepped shaped mating edge and this forms a volume 120. A low modulus elastomer or formed annulus 140 may be used to create a seal and fill the volume 120 while still allowing the central member 108 of the reed 101 to move. This approach allows the reed to move, greatly increases the effective length of the reed, and increases reed compliance.

Weld locations 122 and 124 couple the reed 100 to the housing. The reed 100 mates with the cover/case along surfaces 130 and 132. As shown, the receiver housing that is thereby formed is stepped in configuration.

The approaches described herein provide a flat (non U-shaped reed) with effective lengths that are longer than previous flat reed approaches. The present approaches utilize a stepped cover/cup with a first (rear) portion of the reed remaining unconstrained. By allowing the reed 101 to move, the overall effective length of the reed 101 is increased and the low frequency (LF) sensitivity is increased for a given reed size. As mentioned and in some aspects, the open (rear) section 120 between the reed and the housing could be filled with a low modulus material (e.g., silicon, low modulus epoxy). This allows the case of the receiver 100 to be sealed, but will add only a portion of the stiffness of the case back to the receiver 100.

The dimensions of the various elements described herein can vary. For example, the thickness of the reed 101 can, in one example, be approximately 0.005 inches. The width of each side of the outer member 104 can be approximately 0.030 inches while the length can be approximately 0.120 inches. The width of the central member 108 can be approximately 0.060 inches. It will be appreciated that these are example dimensions only and that other dimensions are possible. The overall length of the reed 101 is approximately 0.120 inches.

As mentioned, the examples of reeds described herein are generally E-shaped and flat in design. However, it will be appreciated that other configures are possible.

Preferred embodiments of the disclosure are described herein, including the best mode known to the inventor. It should be understood that the illustrated embodiments are exemplary only, and should not be taken as limiting the scope of the appended claims.

What is claimed is:

1. A hearing device receiver comprising:
a coil having a passage;
an armature having a deflecting portion, a support portion, and a base portion interconnecting the deflecting portion and the support portion,
the deflecting portion of the armature disposed through the passage of the coil and between magnets of the receiver,
a housing disposed about the coil, the magnets and at least a portion of the armature,
the support portion of the armature fastened to the housing, the base portion of the armature unfastened to the housing,
the deflecting portion of the armature flexible relative to the base and the support portions thereof and free to move between the magnets in response to an excitation signal applied to the coil.

2. The receiver of claim 1, the housing includes first and second housing portions, the support portion of the armature includes lateral side portions disposed and retained between the first and second housing portions, the base portion of the armature being unconstrained by the first and second housing portions.

3. The receiver of claim 2, the first and second housing portions include corresponding outer sidewall portions, the lateral side portions of the armature disposed and retained between the outer sidewall portions of the first and second housing portions.

4. The receiver of claim 2, the housing having an opening into which the base portion of the armature is disposed, a cover disposed over and sealing the opening of the housing, the cover being more compliant than the housing.

5. The receiver of claim 2, the armature is an E-shaped member.

6. The receiver of claim 1, the armature is a substantially planar unitary member.

7. The receiver of claim 2, the lateral side portions of the armature are fastened to the housing by an adhesive.

8. The receiver of claim 2, the lateral side portions of the armature are welded to the housing.

9. A hearing device receiver comprising:
a housing having mating first and second housing portions;
a coil having a coil passage, the coil disposed within the housing;
a pair of spaced magnets at least partially within the housing;
a single-piece substantially planar armature having a central portion and lateral side portions interconnected by a base portion,
the central portion of the armature disposed through the coil passage and between the magnets of the receiver, the lateral side portions of the armature disposed outside the coil passage, the central portion of the armature free to deflect between the magnets of the receiver in response to an excitation signal applied to the coil,
the lateral side portions of the armature disposed and constrained between the first and second portions of the housing, the base portion of the armature unconstrained by the housing; and
a diaphragm coupled to the central portion of the armature.

10. The receiver of claim 9, the housing having an opening into which the base portion of the armature extends, a filler material disposed in and sealing the opening of the housing, the filler material having reduced stiffness relative to the housing, wherein the base portion of the armature is movable relative to the lateral side portions of the armature.

11. The receiver of claim 9, the filler material is a low modulus elastomer.

12. The receiver of claim 9, the armature is an E-shaped member.

13. The receiver of claim 9, the armature, the magnets, and the first and second housing portions constitute a portion of a magnetic circuit.

14. A receiver, the receiver comprising:
a housing having first and second housing portions;
a one-piece armature having a first opening and an outer portion extending about the first opening and a central portion extending in the first opening, the central portion being free to move in the first opening;
a base portion connecting the central portion of the one-piece armature to the outer portion of the one-piece armature;
wherein the first and second housing portions form a second opening that exposes the base portion of the one-piece armature, the base portion not being connected to either of the first housing portion or the second housing portion, the second opening extending across an entire width of the receiver.

15. The receiver of claim 14, further comprising a coil that includes a passage, wherein the central portion of the one-piece armature extends through the passage.

16. The receiver of claim 15, further comprising magnets disposed about the armature.

17. The receiver of claim 14, further comprising a filler material at least partially disposed in the second opening, the filler material more compliant than the first and second housing portions.

18. The receiver of claim 17, wherein the filler material has a reduced stiffness relative to at least one of the first and second housing portions.

19. The receiver of claim 17, wherein the filler material is a low modulus elastomer.

20. The receiver of claim 17, wherein the one-piece armature is an E-shaped member.
